(19) United States
(12) Patent Application Publication
(10) Pub. No.: US 2007/0044926 A1
(43) Pub. Date: Mar. 1, 2007

(54) Accordion shutter system with variable angle connector

(75) Inventor: Jose A. Zuniga, Hialeah, FL (US)

Correspondence Address: MICHAEL J. BUCHENHORNER, 8540 S.W. 83 STREET, MIAMI, FL, 33143, US

(73) Assignee: General Impact Glass and Windows Corp.

(21) Appl. No.: 11/210,053

(22) Filed: Aug. 23, 2005

(51) Int. Cl. E06B 3/48

(52) U.S. Cl. 160/183

(57) ABSTRACT

A shutter system includes a plurality of blades and a plurality of connectors for connecting each blade to another blade. The shutter system also includes bottom and top tracks along which each blade runs. Each connector comprises a plurality of female hinge components and each blade comprises one or more male hinge components, and the male and female hinge components are adapted to connect each blade to another blade.

### FIELD OF THE INVENTION

The invention disclosed broadly relates to the field of storm shutters and more specifically to accordion-type storm shutters.

### BACKGROUND OF THE INVENTION

Storm shutters are commonly used to provide protection against wind damage to structures. There are many types of storm shutters in the market today. There include removable panels and the so-called accordion-type storm shutters. The latter type provide the advantage that they are installed once and then can be rapidly deployed in case of a storm warning. An additional advantage is that when the storm danger is passed, they can be collapsed into a space-saving form and no removal or storage is required. Known accordion-type shutters comprise a plurality of panels, called blades, that are connected to each other by hinges. Each blade has a female hinge at one end and a male hinge at the other end such that one blade is attached to another by inserting the male hinge into the female hinge. The blade assembly includes pins that are inserted into tracks along the top and bottom of the shutter frame. The hinges in present blades only permit a limited range of rotation as the shutter is opened and closed. The inability to connect the blades together such that the angle formed between one blade and another is greater than ninety degrees results in a need for more blades than if the blade assembly could open into a flatter structure. Therefore, there is a need for an accordion-type storm shutter that overcomes that shortcoming.

### SUMMARY OF THE INVENTION

Briefly, according to an embodiment of the invention, a shutter system comprises a plurality of blades, each connected to another blade by a connector having two or more female hinge members, each one for receiving a male hinge member at the end of a blade.

### BRIEF DESCRIPTION OF THE DRAWINGS

FIG. 1 shows a front view of a shutter system according to an embodiment of the invention.

FIG. 2 is a cross sectional view of a blade connector attached to a pair of blades according to an embodiment.

FIG. 3 is a cross sectional top view of the connectors in their compacted (open shutter) position.

FIG. 4 is a top view of a blade with a male hinge at each end according to an aspect of the invention.

FIG. 5 is a cross sectional view of center mating connector.

FIG. 6 is a cross section view of a blade connector allowing a 125 degree angle between a pair of connected blades.

FIG. 7 is a plan view of a blade connector with a pin for running along a track.

### DETAILED DESCRIPTION

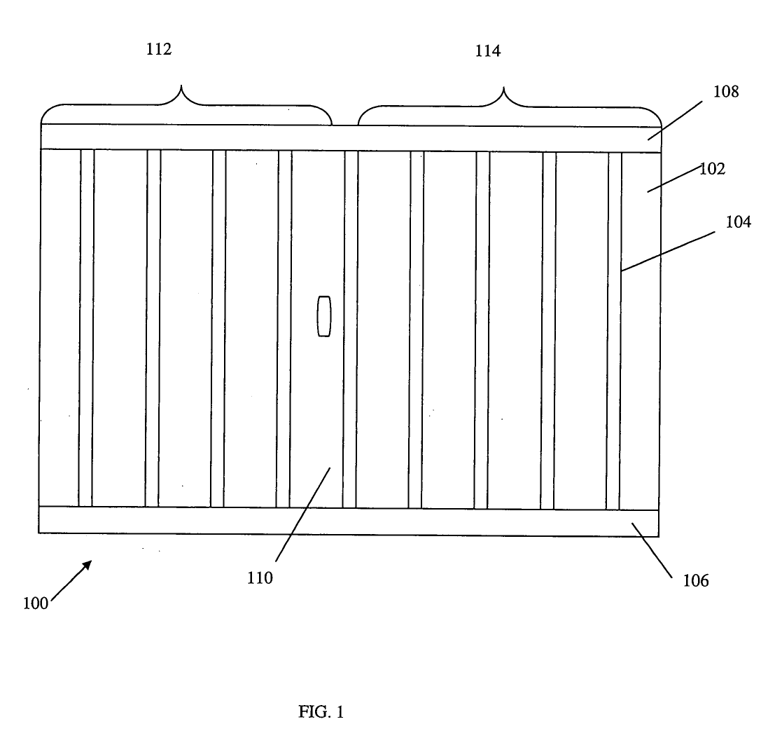

Referring to FIG. 1, there is shown a front view of a shutter system 100 according to an embodiment of the invention. The accordion shutter system 100 includes a plurality of blades 102 and a plurality of connectors 104 for connecting each blade 102 to another blade 102. The shutter system also includes bottom and top tracks along which each blade runs. The shutter system 100 comprises a left side 112 and a right side 114 that can be connected together and locked by a center mating mechanism in central blades 110 and 111 when the shutter is closed.

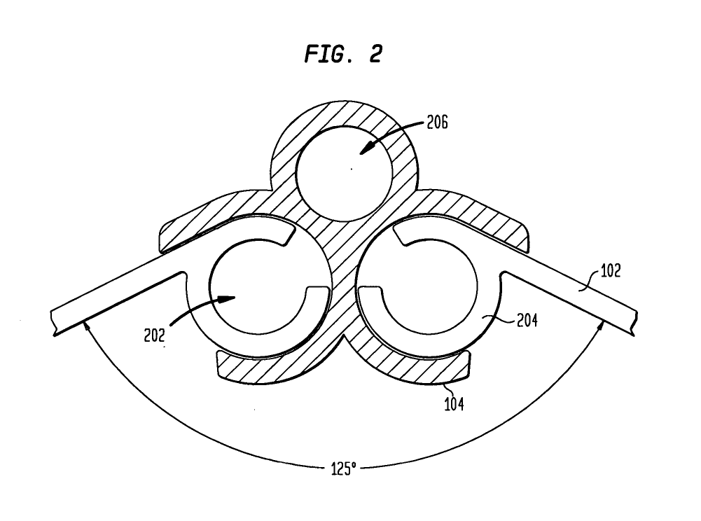

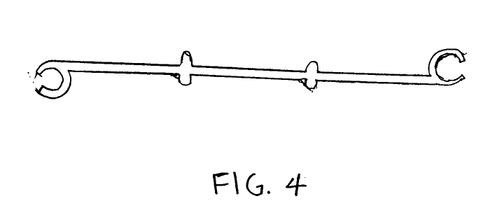

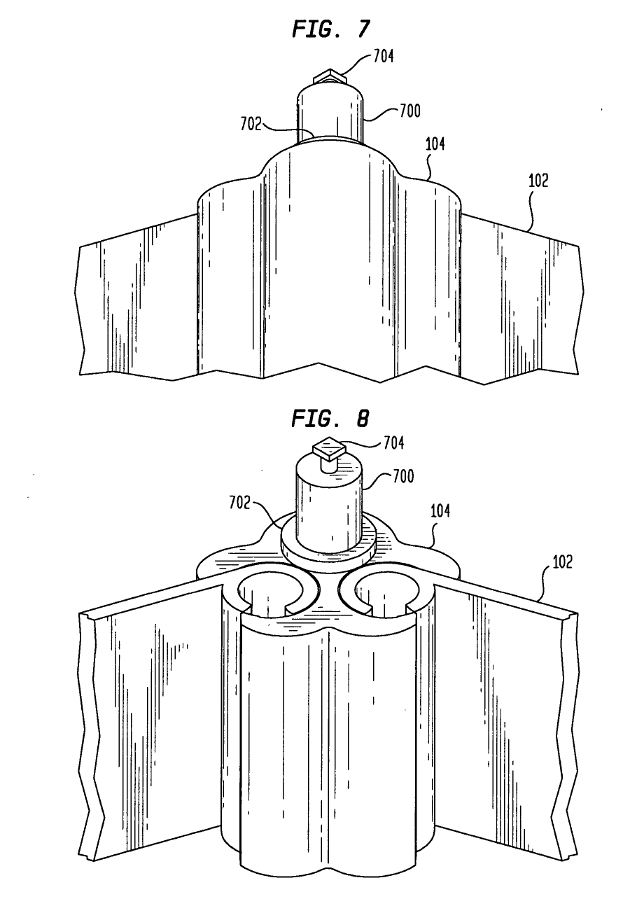

Referring to FIG. 2 there is shown a cross sectional view of a blade connector 104 attached to a pair of blades 102 according to an embodiment. Each connector 104 comprises a pair of female hinge components 202 and each blade comprises a pair of male hinge components 204 (also see FIG. 4), and the male and female hinge components are adapted to connect each blade 102 to another blade 102 with the help of a connector 104. In addition the connector also comprises a tunnel 206 for receiving a rod (not shown) to which a pin 700 (see FIG. 7) is attached for providing smooth running along the blade track. Alternatively the pin 700 can be screwed into the tunnel 206 without the use of a rod. FIG. 2 shows an embodiment of the connector 104 wherein the blades connected to each other form a 125 degree angle with respect to each other. This is not possible in prior art because the hinges are an integral part of the blades allowing at most a ninety degree angle so that the aperture in the hinges can allow rotation while still holding the hinge parts together.

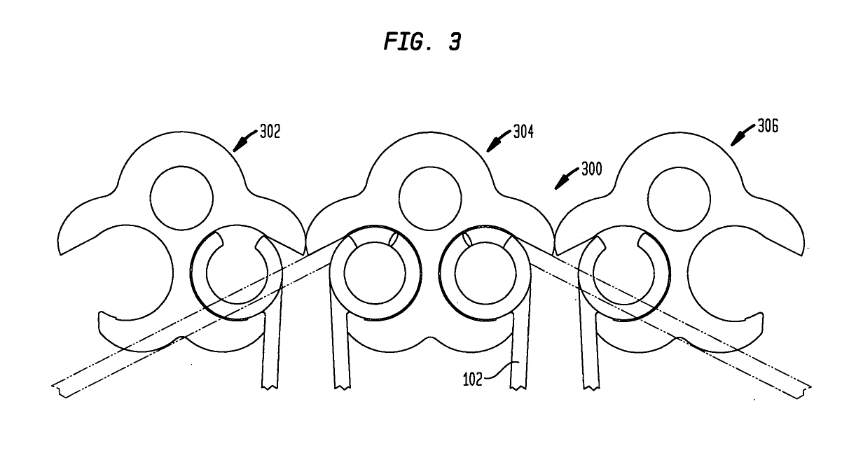

Referring to FIG. 3 there is shown a cross sectional top view 300 of the connectors 302, 304, and 306 in their compacted (open shutter) position. The connector 304 also shows the position of the blades 102 in a closed shutter position. This figure illustrates another advantage of the invention. When the shutter 100 is closed the width of the compacted blade assembly is the sum of the widths of each connector 104 because the blades are substantially in parallel with each other in this position.

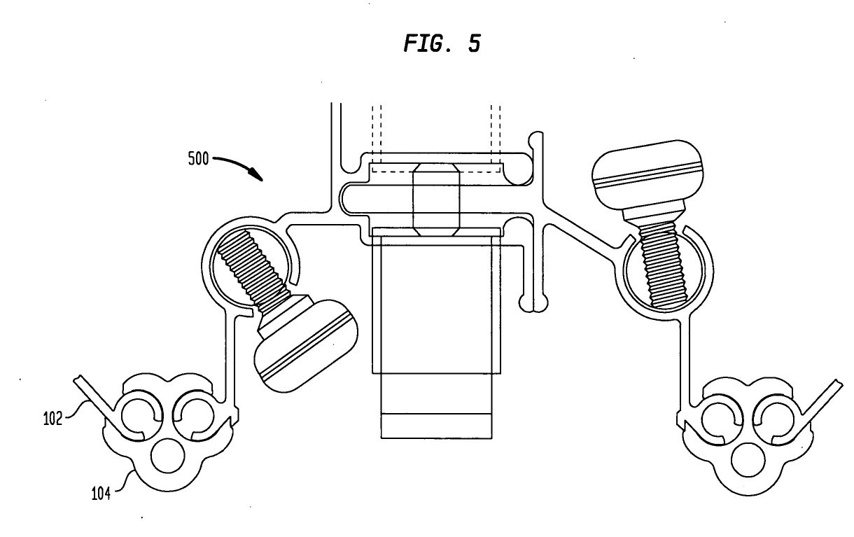

Referring to FIG. 5, there is shown a mating locking mechanism 500 located in the central blades 110 and 111. The locking mechanism 500 comprises a female part 502 and a male part 504 that inserts into a snap fit 506 in the female part 504 to close the shutters 100. The mechanism 500 also includes a button 508 which is depressed to open the shutters. The button 508 includes a key-slot so that when a key is inserted and turned to the locked position the pin 510 locks the mechanism such that it cannot it cannot be opened without the key being reinserted and turned to the unlocked position.

Referring again to FIG. 5, the central blades 110 and 11 also include locking rod/pin tunnels 512 and 516, respectively. Tunnel 512 contains a rod/pin 513 that slides inside it. As the shutter assembly 100 is slid along the tracks once the closed position is reached the locking rod/pins 513 and 520 ling up with holes in the top and bottom tracks. The rod/pins can then be inserted into these holes to keep the shutter assembly in place. The locking rod/pins are held in place by screws 514 and 518. Preferably each tunnel 512 and 516 contains two rod/pins: one for insertion into a hole in the top track and the other for insertion into the bottom track.

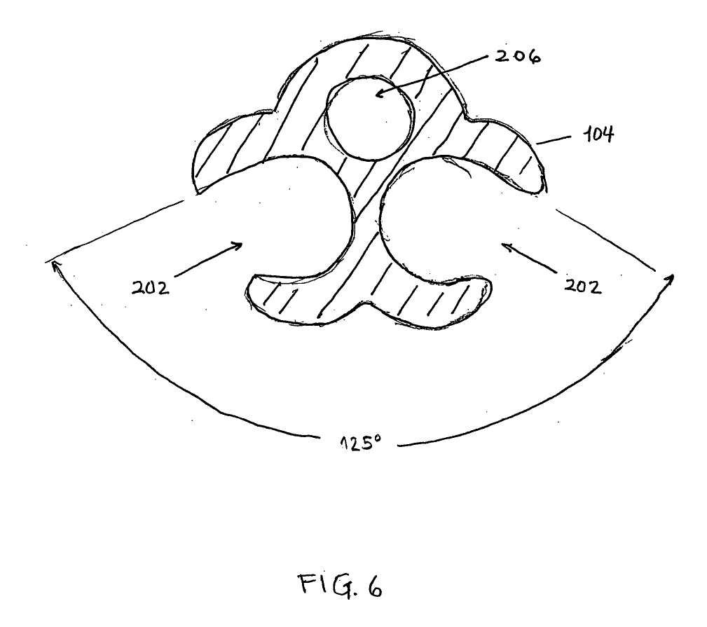

Referring to FIG. 6, there is shown a top cross section of a connector 104. This view clearly shows each of the two female hinge parts 202 (or sockets) for receiving the male socket ends of the blades. The angle of the female hinge parts 202 can be changed from one model of the shutters to another such that the angle of the connected blades varies. For example, in another embodiment the blades can be connected such that in the expanded position they for a ninety degree angle with respect to each other.

Referring to FIG. 7 there is shown an oblique view of a connector 104 with the track pin 700 connected to the connector 104. In this embodiment a washer 702 is disposed between the pin 700 and the connector 104 and the pin is attached to the connector by a screw 704 that connects to the tunnel or round opening 206 of the connector 104. FIG. 8 provides a different view of the assembly of FIG. 7.

The connectors 104 provide additional advantages over the types of accordion shutters where the blades each include a male and a female hinge in that the connector provides additional security and having the sliding pins on the connector makes sliding along the track easier because of the stability of the runner pin position in the connector.

Therefore, while there has been described what is presently considered to be the preferred embodiment, it will understood by those skilled in the art that other modifications can be made within the spirit of the invention.

What is claimed is:

1. A shutter system comprising:
a plurality of blades;
a plurality of connectors for connecting each blade to another blade;
a bottom track along which each blade runs;
a top track along which each blade runs;
wherein each connector comprises two female hinge components and a tunnel for receiving a rod to assist with a running of each blade along the tracks, and each blade comprises two male hinge components, and the male and female hinge components are adapted to connect each blade to another blade, an open position where the plurality of blades are compacted and a closed position where the plurality of blades are expanded.

2. The shutter system of claim 1, further comprising a center connector for connecting a first center end blade to a second center end blade.

3. (canceled)

4. The shutter system of claim 1, wherein each connector comprises a pin attached to each connector to assist with running of each blade along the tracks.

5. The shutter system of claim 1, wherein the system comprises a middle blade.

6. A shutter blade connector comprising:
two female hinge parts, each of the female hinge parts adapted for receiving a male hinge part of a shutter blade; and
a tunnel for receiving a rod to assist with a running of each blade along top and bottom tracks, the tunnel being adjacent to each female hinge part.

7. (canceled)

8. The shutter blade connector of claim 6 further comprising a pin attached to each connector to assist with running of each blade along the tracks.

9. A shutter blade comprising a first end and a second end, each end comprising a male hinge part adapted to fit into a female hinge part in a connector for rotatably connecting shutter blades together.
